(19) United States
(12) Patent Application Publication
(10) Pub. No.: US 2002/0051063 A1
(43) Pub. Date: May 2, 2002

(54) Apparatus and method for processing digital image

(76) Inventor: Jeng-Yan Hwang, Hsinchu (TW)

Correspondence Address: RABIN & CHAMPAGNE, PC, 1101 14TH STREET, NW, SUITE 500, WASHINGTON, DC, 20005, US

(21) Appl. No.: 09/794,107

(22) Filed: Feb. 28, 2001

(30) Foreign Application Priority Data
Oct. 27, 2000 (TW) 89122761

(51) Int. Cl. H04N 5/228

(52) U.S. Cl. 348/231; 348/222

(57) ABSTRACT

A digital image processing apparatus and method for use in an image acquisition system. The image acquisition system further includes an optical device, an analog front-end processing device, and an image temporary storage device. The digital image processing apparatus includes an image processing unit, a memory management unit, a front-end first-in first-out (FIFO) buffering unit, a FIFO buffering unit for writing, and a FIFO buffering unit for reading. The image temporary storage device is used as a buffer for the digital image processing apparatus. The memory management unit is utilized to grant access to the image temporary storage device to either the FIFO buffering unit for reading, the FIFO buffering unit for writing, or the front-end FIFO buffering unit. In this way, it provides high throughput and performance. In addition, it is flexible to be applied to different systems with no significant changes of the systems, and it provides scalability as well as low-cost realization.

This application incorporates by reference Taiwanese application Ser. No. 89122761, filed on Oct. 27, 2000.

### BACKGROUND OF THE INVENTION

1. Field of the Invention

The invention relates in general to an apparatus for image processing, and more particularly to an image processing apparatus by using dynamic scheduling to achieve high throughput, flexibility, and scalability.

2. Description of the Related Art

Information in digital form is easier to be stored and modified than the information in analog form. Thus, information used to be stored in analog form, such as voice and video, is mainly processed and stored digitally nowadays. For example, in an image acquisition system, such as a digital camera or scanning apparatus, the acquired analog image signal is converted into digital image data, and the digital image data after digital image processing is then transferred to a host for storage.

Referring to FIG. 1, it illustrates a conventional image acquisition system in block diagram form. The image acquisition system includes an optical device 102, an analog front-end 104, an image temporary storage device 116, and a digital image processing apparatus 106.

In the image acquisition system, the optical device 102, such as charge-coupled device (CCD) or contact image sensor (CIS), is employed to convert an image into analog signals.

The analog front-end 104, which is coupled to the optical device 102, is used for converting the analog signals into digital signals, separating the digital signals into components which are being carried in different channels for primary colors, red, green, and blue, and making adjustments of the components by modifying the amplitudes of and adding offsets to the components.

The digital image processing apparatus 106 is coupled to the analog front-end 104 and outputs digital image to a host after processing the digital signals received from the analog front-end 104. The digital image processing apparatus 106 includes a front-end digital compensation and adjustment unit 108, a back-end digital compensation and adjustment unit 110, a buffer write unit 112, and a buffer read unit 114. The front-end digital compensation and adjustment unit 108, coupled to the analog front-end 104 and receiving the output of the analog front-end 104, is employed for front-end image processing. For instance, the front-end image processing makes compensation and enhancement for the digital signals' image distortion due to defects and non-uniformity of the optical device 102. For back-end image processing, the back-end digital compensation and adjustment unit 110 is coupled to the front-end digital compensation and adjustment unit 108. For example, the back-end image processing is to fulfill the requirements of the host, such as converting digital image into different file formats, RGB and YMCK conversions, Gamma function mapping due to different characteristics between different devices, image quality enhancement, and image data compression. Next, since throughputs of the units mentioned above are non-uniform, they require the image temporary storage device 116 as a buffer for them. In addition, the image temporary storage device 116 stores different tables that are to be read by the front-end digital compensation and adjustment unit 108 and the back-end digital compensation and adjustment unit 110 during making compensation and adjustment. Further, for writing the output image data of the back-end digital compensation and adjustment unit 110 into the image temporary storage device 116, the buffer write unit 112 is used and coupled between the image temporary storage device 116 and the back-end digital compensation and adjustment unit 110. Finally, the buffer read unit 114 is coupled to the image temporary storage device 116 and is used for reading and transferring required image data to the host 118.

Referring to FIG. 2, it illustrates a state transition diagram for access control by applying a round-robin approach to the image temporary storage device 116. Since the image temporary storage device 116 is to be accessed by the front-end digital compensation and adjustment unit 108, the buffer read unit 114, the back-end digital compensation and adjustment unit 110, and the buffer write unit 112, the image temporary storage device 116, correspondingly, has the following states: a front-end state 202, read state 204, back-end state 206, and write state 208. In addition, the image temporary storage device 116 has a wait state 210, corresponding to the image temporary storage device 116 remaining idle, waiting for image signals.

Specifically, before making digital compensation and adjustment, the front-end digital compensation and adjustment unit 108 and the back-end digital compensation and adjustment unit 110 read their respective tables for compensation and adjustment from the image temporary storage device 116 directly. After reading the required tables for compensation and adjustment, the front-end digital compensation and adjustment unit 108 and the back-end digital compensation and adjustment unit 110 access the image temporary storage device 116 through the buffer write unit 112 and buffer read unit 114.

The state transition in FIG. 2 is described as follows. The image temporary storage device 116 is initially in the wait state 210. When image data are inputted to the image acquisition apparatus, the image temporary storage device 116 goes to the front-end state 202. In the front-end state 202, the front-end digital compensation and adjustment unit 108 reads the table for compensation and adjustment in the front-end image processing, and the image temporary storage device 116 then enters the read state 204. In the read state 204, image data required by the host 118 is read from the image temporary storage device 116 through the buffer read unit 114, and a determination is then made whether the back-end digital compensation and adjustment unit 110 requires to read the table for the back-end image processing. If so, the image temporary storage device 116 goes to the back-end state 206 to read the required table. If not, the write state 208 is entered to write the image data into the image temporary storage device 116, and the image temporary storage device 116 then returns to the wait state 210.

The scheduling indicated by the state transition diagram above is static and the scheduling is made according to the sequence of access to the image temporary storage device 116 by the front-end digital compensation and adjustment unit 108, the buffer read unit 114, the back-end digital compensation and adjustment unit 110, and the buffer write unit 112. According to the architecture and the scheduling above, the image temporary storage device 116 can be shared with the four units, resulting in a simple and low-cost architecture. However, this simple architecture has the disadvantage that the throughput is restricted. For real-time applications, the requirement for throughput cannot be achieved completely. In addition, the units access the image temporary storage device 116 with random addresses so that each time before a unit accesses the image temporary storage device 116, an initial operation is necessary to be done. Thus, the time for the initial operation increases the access time to the image temporary storage device 116. In this way, the static scheduling above is low-cost and simple in architecture, but the image temporary storage device 116 is not used effectively, resulting in limitations to the speed and throughput. Besides, due to the static scheduling, it lacks flexibility and scalability.

For a more effective use of the image temporary storage device, another conventional approach is illustrated in FIG. 3, which is a modification of the image acquisition apparatus as shown in FIG. 1. In FIG. 3, the front-end digital compensation and adjustment unit 108 and the back-end digital compensation and adjustment unit 110 have their respective memories 302 and 304, such as static random access memory (SRAM). In addition, the image temporary storage device 116 is only accessible to the buffer write unit 112 and the buffer read unit 114. Thus, throughput of the image temporary storage device may be increased. However, the use of the memories 302 and 304 has the disadvantages that the total cost is thus increased and they are incapable of being shared even when they are not in use.

### SUMMARY OF THE INVENTION

It is therefore an object of the invention to provide a high throughput, flexible, scalable digital image processing apparatus.

According to the object of the invention, it provides a digital image processing apparatus for use in an image acquisition system. The image acquisition system further includes an optical device, an analog front-end processing device, and an image temporary storage device. The optical device is used for converting an image into analog data electronically. The analog front-end processing device, coupled to the optical device, is used for converting the analog data into digital image data. The digital image processing apparatus, coupled to the analog front-end processing device, is utilized to process the digital image data and output the digital image data after processing to a host. The image temporary storage device, coupled to the digital image processing apparatus, is used as a buffer for the digital image processing apparatus. The digital image processing apparatus includes an image processing unit, a memory management unit, a front-end first-in first-out (FIFO) buffering unit, a FIFO buffering unit for writing, and a FIFO buffering unit for reading. The image processing unit, coupled to the analog front-end processing device, is used for receiving the digital image data and performing front-end processing on the digital image data. The memory management unit, coupled to the image temporary storage device, is utilized to determine access to the image temporary storage device. The FIFO buffering unit, coupled to the image processing unit and the memory management unit, is used for providing a table for the image processing unit for performing front-end processing, wherein when the front-end FIFO buffering unit obtains the access to the image temporary storage device through the memory management unit, the front-end FIFO buffering unit reads the table from the image temporary storage device. The FIFO buffering unit for writing, coupled to the image processing unit and the memory management unit, is used for storing data outputted by the image processing unit, wherein when the FIFO buffering unit for writing obtains the access to the image temporary storage device through the memory management unit, the FIFO buffering unit for writing writes contents of the FIFO buffering unit for writing into the image temporary storage device. The FIFO buffering unit for reading is coupled to the memory management unit, wherein when the FIFO buffering unit for reading obtains the access to the image temporary storage device through the memory management unit, the FIFO buffering unit for reading reads image data required by the host from the image temporary storage device and outputs the image data required by the host to the host.

### BRIEF DESCRIPTION OF THE DRAWINGS

Other objects, features, and advantages of the invention will become apparent from the following detailed description of the preferred but non-limiting embodiments. The description is made with reference to the accompanying drawings, in which:

FIG. 1 (Prior Art) is a block diagram of a conventional image acquisition apparatus;

FIG. 2 (Prior Art) is a state transition diagram for access control in the image acquisition apparatus as shown in FIG. 1;

FIG. 3 (Prior Art) is a block diagram of another conventional image acquisition apparatus;

FIG. 4 is a block diagram of an image acquisition apparatus to which a preferred embodiment of a digital image processing apparatus according to the invention is applied;

FIG. 5 is a block diagram of an image acquisition apparatus to which another embodiment of a digital image processing apparatus corresponding to the one in FIG. 4.; and

FIG. 6 is a state transition diagram for the access arbitration unit in the embodiment as shown in FIG. 5.

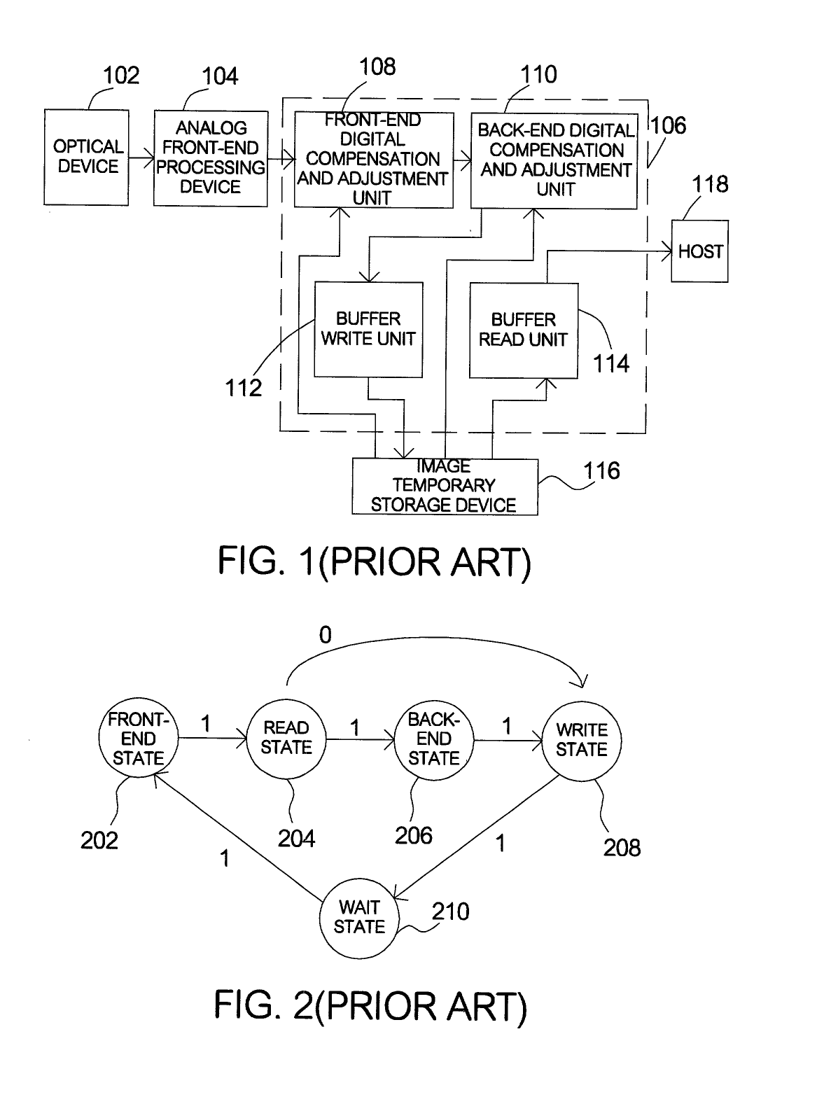

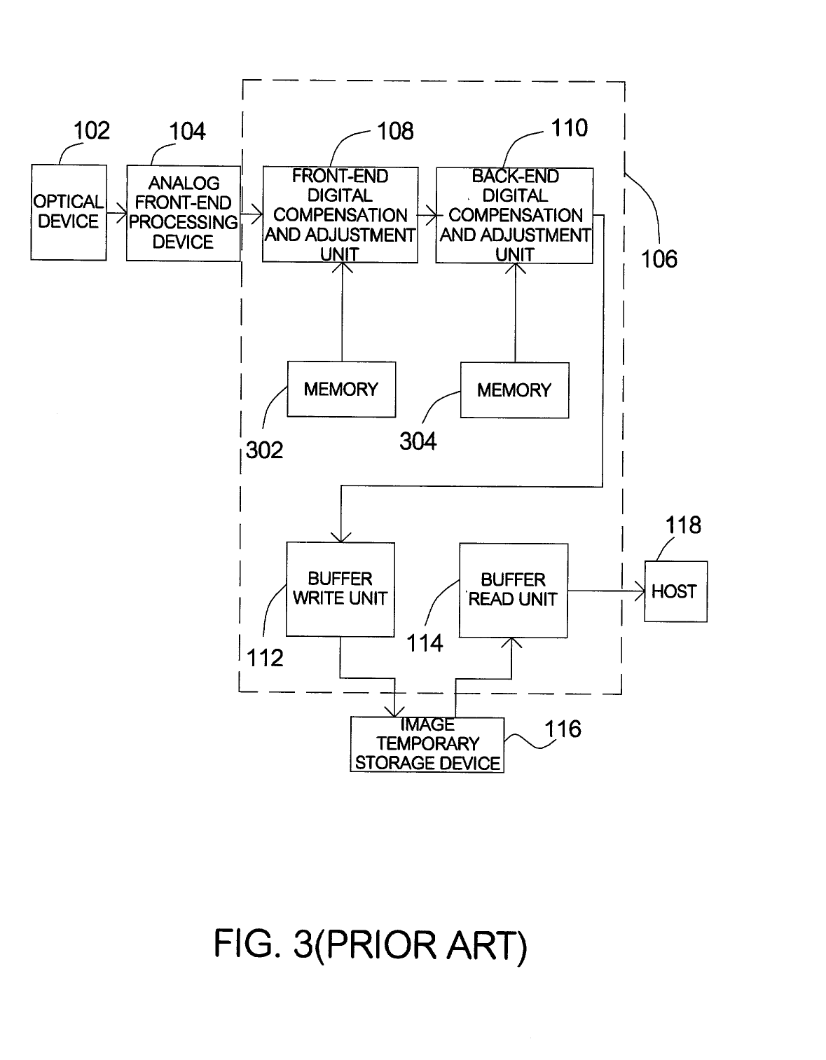

### DETAILED DESCRIPTION OF THE INVENTION

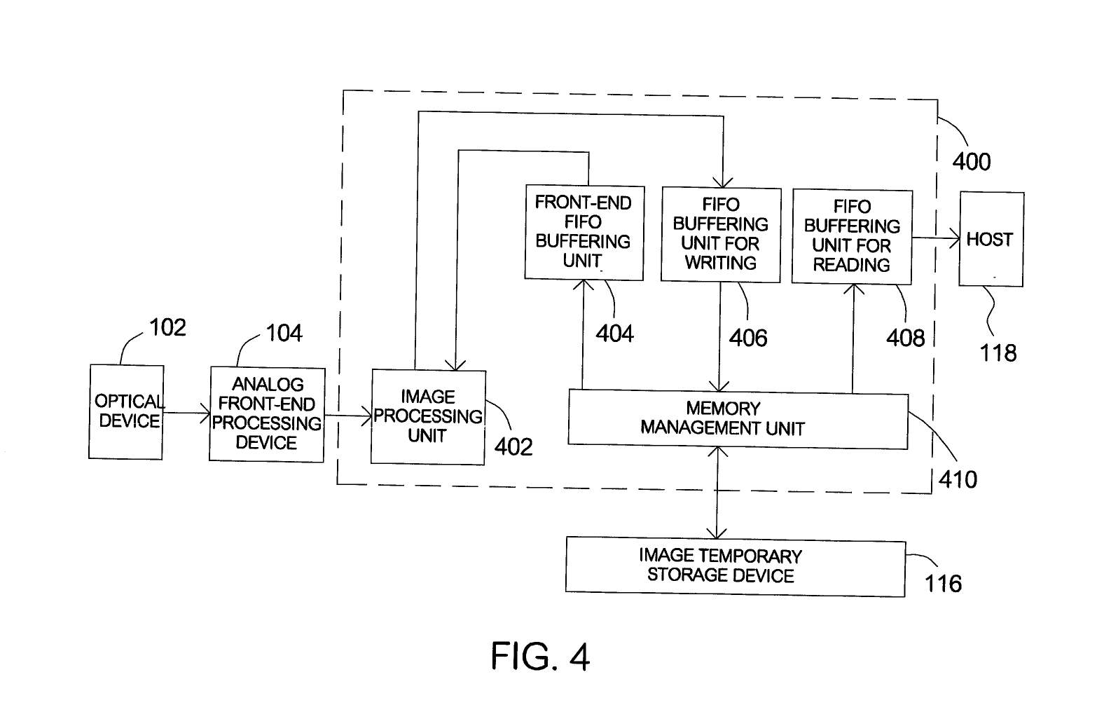

Referring to FIG. 4, it illustrates an image acquisition system to which a preferred embodiment of a digital image processing apparatus according to the invention is applied. The image acquisition system further includes an optical device 102, an analog front-end processing device 104, and an image temporary storage device 116. The optical device is used for converting images into analog data electronically. The analog front-end processing device 104 is coupled to the optical device 102 and used for converting the analog data into digital image data which contain different channels indicating components of the analog data in terms of the primary colors, red, green, and blue. In addition, the analog front-end processing device 104 makes adjustments of the components by modifying the amplitudes of and adding offsets to the components. The digital image processing apparatus 400 is coupled to the analog front-end processing device 104 and is employed to process the digital image data and to output the digital image data after processing to a host 118. The image temporary storage device 116 is coupled to the digital image processing apparatus 400 and used as a buffer thereof.

The digital image processing apparatus 400 includes an image processing unit 402, a memory management unit 410, a front-end first-in first-out (FIFO) buffering unit 404, a FIFO buffering unit for writing 406, and a FIFO buffering unit for reading 408. The image processing unit 402 is coupled to the analog front-end processing device 104 and is utilized to receive the digital image data outputted by the analog front-end processing device 104 and perform front-end image processing of the digital image data, such as making adjustment of the digital image data to compensate for image distortion due to defects and non-conformity of the optical device. The memory management unit 410, coupled to the image temporary storage device 116, is employed to determine access to the image temporary storage device 116. The front-end FIFO buffering unit 404, coupled to the image processing unit 402 and the memory management unit 410, is used for providing a table for the image processing unit, wherein the table is required by the image processing unit for performing front-end processing. Preferably, the table is read in advance. When the front-end FIFO buffering unit 404 obtains the access to the image temporary storage device 116 through the memory management unit 410, the front-end FIFO buffering unit 404 reads the table required by the image processing unit 402 from the image temporary storage device 116. The FIFO buffering unit for writing 406, coupled to the image processing unit 402 and the memory management unit 410, is used for storing data outputted by the image processing unit 402. In addition, when the FIFO buffering unit for writing 406 obtains the access to the image temporary storage device 116 through the memory management unit 410, the FIFO buffering unit for writing 406 stores its contents in the image temporary storage device 116. The FIFO buffering unit for reading 408 is coupled to the memory management unit 410. Once obtaining the access to the image temporary storage device 116 through the memory management unit 410, the FIFO buffering unit for reading 408 reads image data required by the host 118 from the image temporary storage device 116 and outputs the image data to the host 118.

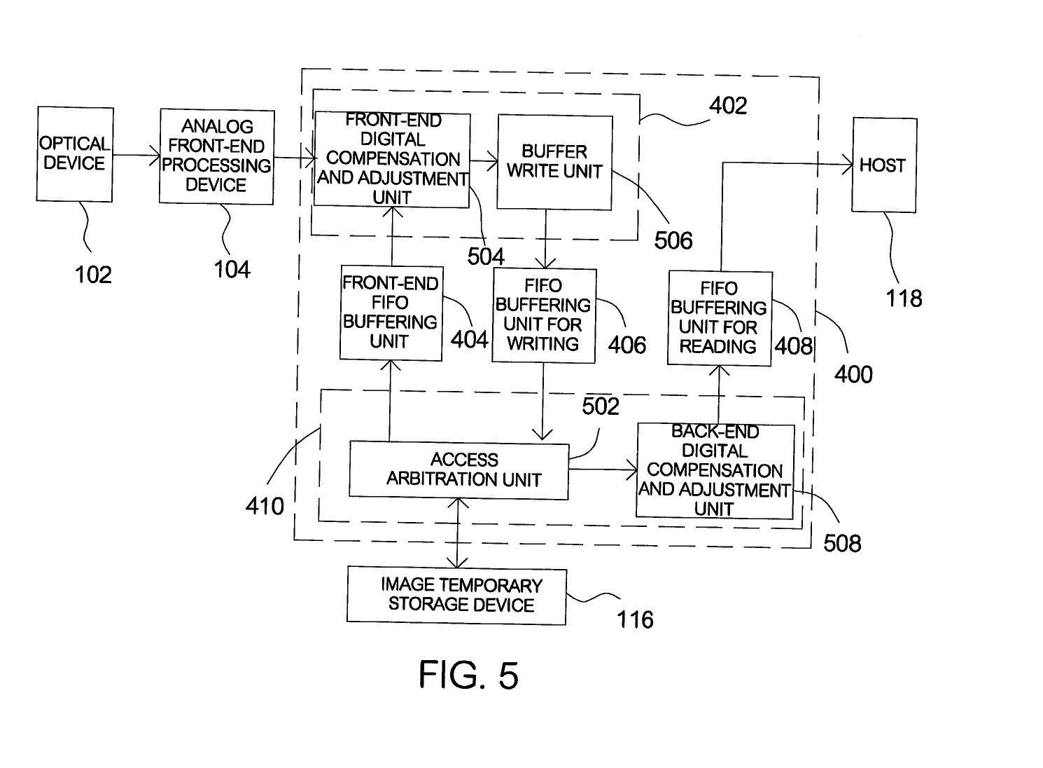

Referring to FIG. 5, it illustrates an image acquisition apparatus to which another embodiment corresponding to the digital image processing apparatus in FIG. 4 is applied. In FIG. 5, the image processing unit 402 includes a front-end digital compensation and adjustment unit 504 and a buffer write unit 506. Besides, the memory management unit 410 includes an access arbitration unit 502 and a back-end digital compensation and adjustment unit 508.

The front-end digital compensation and adjustment unit 504, coupled to the analog front-end processing device 104, is employed to receive digital image data outputted by the analog front-end processing device 104 and to perform front-end image processing of the digital image data, such as to make adjustment of the digital image data to compensate for image distortion due to defects and non-conformity of the optical device. Then, the buffer write unit 506, coupled to the front-end digital compensation and adjustment unit 504, is utilized to receive digital image data outputted by the front-end digital compensation and adjustment unit 504, to adjust color depth of the output digital image data of the front-end digital compensation and adjustment unit 504, and then to output the digital image data after adjustment to the FIFO buffering unit for writing 406. An example of adjusting the color depth of the digital image data is to lower the color depth of the digital data from 16-bit to 1-bit. Besides, the access arbitration unit 502 is coupled to the image temporary storage device 116, the front-end FIFO buffering unit 404, the FIFO buffering unit for writing 406, and the FIFO buffering unit for reading 408 respectively. In addition, the access arbitration unit 502 is used for determining access to the image temporary storage device 116. The back-end digital compensation and adjustment unit 508 is coupled to the FIFO buffering unit for reading 408 and the access arbitration unit 502. When the FIFO buffering unit for reading 408 obtains the access to the image temporary storage device 116, contents of the image temporary storage device 116 are first transferred to the back-end digital compensation and adjustment unit 508. Then, according to requirements of the host 118, the back-end digital compensation and adjustment unit 508 performs back-end image processing of the contents, resulting in required digital image data. Next, the FIFO buffering unit for reading 408 transfers the required digital image data to the host 118. In the back-end image processing, the digital image data are processed to obtain outputs according to the requirements of the host 118, such as converting the digital image data into data in different image format, converting the digital image data from RGB to YMCK, performing Gamma function mapping due to the characteristics between different devices, enhancing image quality, or compression of image data. As to the image temporary storage device 116, it can be constructed by using dynamic random access memory (DRAM), such as synchronous DRAM (SDRAM).

Initially, the front-end FIFO buffering unit 404 sends a front-end request for filling the front-end FIFO buffering unit 404 with data to the access arbitration unit 502. Then, the front-end FIFO buffering unit 404 sends the front-end request when (1a) an amount of valid data of the front-end FIFO buffering unit 404 is less than a front-end threshold, and (1b) the front-end FIFO buffering unit 404 does not obtain the access to the image temporary storage device 116, and (1c) data processed by the front-end digital compensation and adjustment unit are not the last data. Besides, in the condition (1c), for example, if an image is processed line by line, the last data mentioned in (1c) correspond to data of the last line of the image.

As for the FIFO buffering unit for writing 406, it has no valid data initially and it sends a write request to the access arbitration unit 502 when (2a) an amount of valid data of the FIFO buffering unit for writing 406 is greater than a write threshold or the valid data of the FIFO buffering unit for writing 406 are the last valid data, and (2b) the FIFO buffering unit for writing does not obtain the access to the image temporary storage device.

For the FIFO buffering unit for reading 408, it has no valid data initially and it sends a read request to the access arbitration unit 502 when (3a) an amount of valid data of the FIFO buffering unit for reading is less than a read threshold, and (3b) an amount of valid data of the image temporary storage device is not zero.

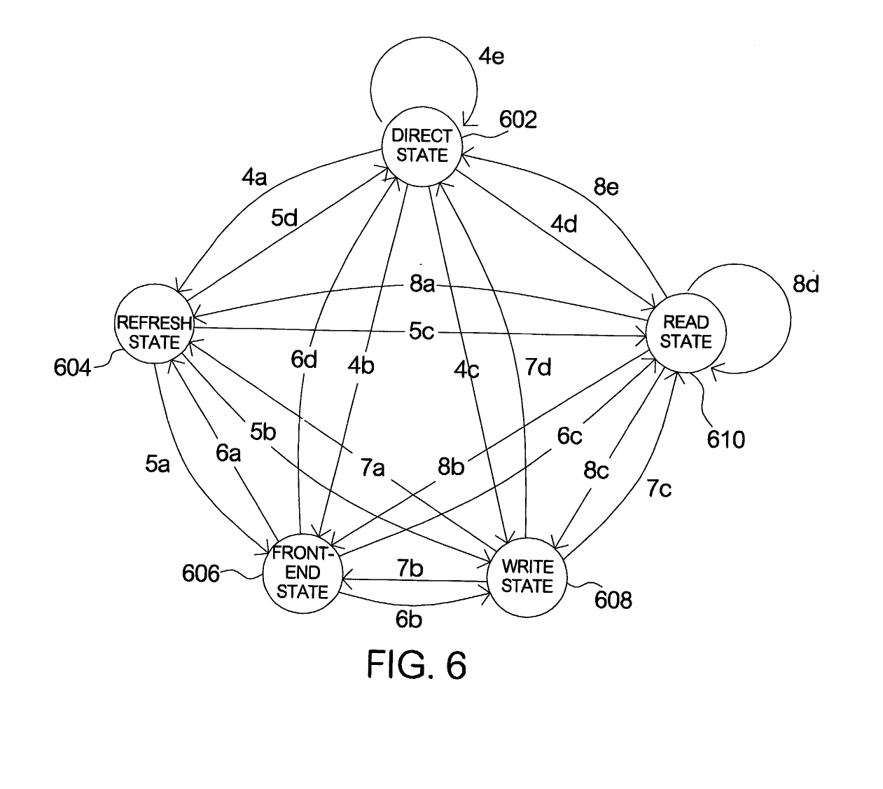

Referring to FIG. 6, it illustrates a state transition diagram of the access arbitration unit 502, wherein the access arbitration unit 502 uses dynamic scheduling for determining access to the image temporary storage device 116. The access arbitration unit 502 determines whether the front-end FIFO buffering unit 404, or the FIFO buffering unit for reading 408, or the FIFO buffering unit for writing 406 has a request for updating data, such as the front-end request, write request, or read request mentioned above. If it is determined that there is a unit having a request for updating data, the access arbitration unit 502 selects the unit (if only one unit has the request) or selects one unit from the units that have their respective requests for updating data. The access arbitration unit 502 has a direct state 602, a refresh state 604, a front-end state 606, a write state 608, and a read state 610. When the access arbitration unit 502 is in the direct state 602, it indicates that the image temporary storage device 116 is accessible directly for testing or initialization. When the access arbitration unit 502 is in the refresh state 604, it indicates that contents of the image temporary storage device 116 requires to be refreshed due to the characteristics of SDRAM. Besides, it should be noted that, for memory devices that do not require to be refreshed during operation such as static random access memory (SRAM), the refresh state is unnecessary. When the access arbitration unit 502 is in the front-end state 606, it indicates that the front-end FIFO buffering unit 404 obtains the access to the image temporary storage device 116. When the access arbitration unit 502 is in the write state 608, it indicates that the FIFO buffering unit for writing 406 obtains the access to the image temporary storage device 116. When the access arbitration unit 502 is in the read state 610, it indicates that the FIFO buffering unit for reading 408 obtains the access to the image temporary storage device 116.

When the access arbitration unit 502 is in the direct state 602, actions of the state is ended off with a determination of the access to the image temporary storage device 116. The determination is made by the following steps. (4a) The access arbitration unit 502 determines whether there is a request for refreshing; if so, the access arbitration unit 502 changes to the refresh state 604 and performs refresh operation. (4b) The access arbitration unit 502 determines whether there is a request for updating data of the front-end FIFO buffering unit; if so, the access arbitration unit 502 goes to the front-end state 606 and performs according to the request for updating data of the front-end FIFO buffering unit 404. (4c) The access arbitration unit 502 determines whether there is a request for updating data of the FIFO buffering unit for writing 406; if so, the access arbitration unit 502 changes to the write state 608 and performs according to the request for updating data of the FIFO buffering unit for writing 406. (4d) The access arbitration unit 502 determines whether there is a request for updating data of the FIFO buffering unit for reading 408; if so, the access arbitration unit 502 enters the read state 610 and performs according to the request for updating data of the FIFO buffering unit for reading 408. (4e) If the access arbitration unit 502 detects no request as indicated in step (4a), (4b), (4c), or (4d), the access arbitration unit 502 remains in the direct state 602.

When the access arbitration unit 502 is in the refresh state 604, actions of the state is ended off with an arbitration for the access to the image temporary storage device 116. The determination is made by the following steps. (5a) The access arbitration unit 502 determines whether there is a request for updating data of the front-end FIFO buffering unit 404; if so, the access arbitration unit 502 goes to the front-end state 606 and performs according to the request for updating data of the front-end FIFO buffering unit 404. (5b) The access arbitration unit 502 determines whether there is a request for updating data of the FIFO buffering unit for writing 406; if so, the access arbitration unit 502 changes to the write state 608 and performs according to the request for updating data of the FIFO buffering unit for writing 406. (5c) The access arbitration unit 502 determines whether there is a request for updating data of the FIFO buffering unit for reading 408; if so, the access arbitration unit 502 enters the read state 610 and performs according to the request for updating data of the FIFO buffering unit for reading 408. (5d) If the access arbitration unit 502 detects that no request as indicated in step (5a), (5b), or (5c), the access arbitration unit 502 goes to the direct state 602.

When the access arbitration unit 502 is in the front-end state 606, actions of the state is ended off with a determination of the access to the image temporary storage device 116. The determination is made by the following steps. (6a) The access arbitration unit 502 determines whether there is a request for refreshing; if so, the access arbitration unit 502 changes to the refresh state 604 and performs refresh operation. (6b) The access arbitration unit 502 determines whether there is a request for updating data of the FIFO buffering unit for writing 406; if so, the access arbitration unit 502 changes to the write state 608 and performs according to the request for updating data of the FIFO buffering unit for writing 406. (6c) The access arbitration unit 502 determines whether there is a request for updating data of the FIFO buffering unit for reading 408; if so, the access arbitration unit 502 enters the read state 610 and performs according to the request for updating data of the FIFO buffering unit for reading 408. (6d) If the access arbitration unit 502 detects no request as indicated in step (6a), (6b), or (6c), the access arbitration unit 502 goes to the direct state 602.

When the access arbitration unit 502 is in the write state 608, actions of the state is ended off with a determination of the access to the image temporary storage device 116. The determination is made by the following steps. (7a) The access arbitration unit 502 determines whether there is a request for refreshing; if so, the access arbitration unit 502 changes to the refresh state 604 and performs refresh operation. (7b) The access arbitration unit 502 determines whether there is a request for updating data of the front-end FIFO buffering unit 404; if so, the access arbitration unit 502 goes to the front-end state 606 and performs according to the request for updating data of the front-end FIFO buffering unit 404. (7c) The access arbitration unit 502 determines whether there is a request for updating data of the FIFO buffering unit for reading 408; if so, the access arbitration unit 502 enters the read state 610 and performs according to the request for updating data of the FIFO buffering unit for reading 408. (7d) If the access arbitration unit 502 detects no request as indicated in step (7a), (7b), or (7c), the access arbitration unit 502 goes to the direct state 602.

When the access arbitration unit 502 is in the read state 610, actions of the state is ended off with a determination of the access to the image temporary storage device 116. The determination is made by the following steps. (8a) The access arbitration unit 502 determines whether there is a request for refreshing; if so, the access arbitration unit 502 changes to the refresh state 604 and performs refresh operation. (8b) The access arbitration unit 502 determines whether there is a request for updating data of the front-end FIFO buffering unit 404; if so, the access arbitration unit 502 goes to the front-end state 606 and performs according to the request for updating data of the front-end FIFO buffering unit 404. (8c) The access arbitration unit 502 determines whether there is a request for updating data of the FIFO buffering unit for writing 406; if so, the access arbitration unit 502 changes to the write state 608 and performs according to the request for updating data of the FIFO buffering unit for writing 406. (8d) The access arbitration unit 502 determines whether there is a request for updating data of the FIFO buffering unit for reading 408; if so, the access arbitration unit 502 enters the read state 610 and performs according to the request for updating data of the FIFO buffering unit for reading 408. (8e) If the access arbitration unit 502 detects no request as indicated in step (8a), (8b), (8c), or (8d), the access arbitration unit 502 enters the direct state 602.

In the embodiments disclosed above, a packet in a suitable size can be used as a data unit to be written into or read from the image temporary storage device. Thus, the image temporary storage device, such as one formed by SDRAM, can operate in a burst transfer mode so as to increase the data transfer rate of the image temporary storage device. Besides, the access to the image temporary storage device is determined by the dynamic scheduling as described above so that the image temporary storage device is used more efficiently, and thus providing high throughput and high performance. Further, parameters such as the size of packets, the front-end threshold, the write threshold, and the read threshold are adjustable. In this way, when the invention is applied to a system for a specific application, these parameters can be adjusted to the requirements of the system. Thus, by the invention, flexibility in system design and integration is further provided. Moreover, to fulfill different application requirements, adding new processing mechanisms to or modifying the processing mechanisms in the image processing unit, the front- and back-end digital compensation, or adjustment units are readily with no significant changes in the digital image processing apparatus according to the invention. In other words, the invention also provides a scalable and flexible architecture. In this way, according to the invention, the digital image processing apparatus provides high throughput, flexibility, and scalability as well as low-cost realization.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A digital image processing apparatus for use in an image acquisition system, the image acquisition system further comprising an optical device, an analog front-end processing device, and an image temporary storage device, the optical device for converting an image into analog data electronically, the analog front-end processing device, coupled to the optical device, for converting the analog data into digital image data, the digital image processing apparatus, coupled to the analog front-end processing device, for processing the digital image data and outputting the digital image data after processing to a host, the image temporary storage device, coupled to the digital image processing apparatus, being used as a buffer for the digital image processing apparatus, the digital image processing apparatus comprising:
an image processing unit, coupled to the analog front-end processing device, for receiving the digital image data and performing front-end processing on the digital image data;
a memory management unit, coupled to the image temporary storage device, for determining access to the image temporary storage device;
a front-end first-in first-out (FIFO) buffering unit, coupled to the image processing unit and the memory management unit, for providing a table for the image processing unit for performing front-end processing, and wherein when the front-end FIFO buffering unit obtains the access to the image temporary storage device through the memory management unit, the front-end FIFO buffering unit reads the table from the image temporary storage device;
a FIFO buffering unit for writing, coupled to the image processing unit and the memory management unit, for storing data outputted by the image processing unit, wherein when the FIFO buffering unit for writing obtains the access to the image temporary storage device through the memory management unit, the FIFO buffering unit for writing writes contents of the FIFO buffering unit for writing into the image temporary storage device; and
a FIFO buffering unit for reading, coupled to the memory management unit, wherein when the FIFO buffering unit for reading obtains the access to the image temporary storage device through the memory management unit, the FIFO buffering unit for reading reads image data required by the host from the image temporary storage device and outputs the image data required by the host to the host.

2. A digital image processing apparatus according to claim 1, wherein the image processing unit comprises:
a front-end digital compensation and adjustment unit, coupled to the analog front-end processing device, for receiving the digital image data and perform front-end image processing on the digital image data.

3. A digital image processing apparatus according to claim 2, wherein the image processing unit further comprises:
a buffer write unit, coupled to the front-end digital compensation and adjustment unit, for receiving data outputted by the front-end digital compensation and adjustment unit, adjusting color depth of the data outputted by the front-end digital compensation and adjustment unit, and outputting a result of the data after color depth adjusting to the FIFO buffering unit for writing.

4. A digital image processing apparatus according to claim 1, wherein the memory management unit further comprises:
an access arbitration unit, coupled to the image temporary storage device, the FIFO buffering unit for reading, the FIFO buffering unit for writing, and the front-end FIFO buffering unit respectively, the access arbitration unit for determining access to the image temporary storage device, wherein the access arbitration unit determines that the access to the image temporary storage device is granted to either the FIFO buffering unit for reading, the FIFO buffering unit for writing, or the front-end FIFO buffering unit; and
a back-end digital compensation and adjustment unit, coupled to the FIFO buffering unit for reading and the access arbitration unit, for performing back-end processing, wherein when the FIFO buffering unit for reading obtains the access to the image temporary storage device, contents of the image temporary storage device are outputted to the back-end digital compensation and adjustment unit, and after performing back-end processing on the contents of the image temporary storage device, the back-end digital compensation and adjustment unit outputs a result data to the FIFO buffering unit for reading.

5. A digital image processing apparatus for use in an image acquisition system, the image acquisition system further comprising an optical device, an analog front-end processing device, and an image temporary storage device, the optical device for converting an image into analog data electronically, the analog front-end processing device, coupled to the optical device, for converting the analog data into digital image data, the digital image processing apparatus, coupled to the analog front-end processing device, for processing the digital image data and outputting the digital image data after processing to a host, the image temporary storage device, coupled to the digital image processing apparatus, being use as a buffer for the digital image processing apparatus, the digital image processing apparatus comprising:
a front-end digital compensation and adjustment unit, coupled to the analog front-end processing device, for receiving the digital image data and making adjustment of the digital image data to compensate for image distortion due to the optical device's defect and non-uniformity;
an access arbitration unit, coupled to the image temporary storage device, for determining access to the image temporary storage device;
a front-end first-in first-out (FIFO) buffering unit, coupled to the front-end digital compensation and adjustment unit and the access arbitration unit, wherein when the front-end FIFO buffering unit obtains the access to the image temporary storage device, the front-end FIFO buffering unit reads a table required by the front-end digital compensation and adjustment unit from the image temporary storage device;
a buffer write unit, coupled to the front-end digital compensation and adjustment unit, for receiving data outputted by the front-end digital compensation and adjustment unit;
a FIFO buffering unit for writing, coupled to the buffer write unit, for storing data outputted by the buffer write unit, wherein when the FIFO buffering unit for writing obtains the access to the image temporary storage device through the access arbitration unit, the FIFO buffering unit for writing writes contents of the FIFO buffering unit for writing to the image temporary storage device;
a back-end digital compensation and adjustment unit, coupled to the access arbitration unit, for back-end image processing according to a requirement by the host; and
a FIFO buffering unit for reading, coupled to the back-end digital compensation and adjustment unit, wherein when the FIFO buffering unit for reading obtains the access to the image temporary storage device through the access arbitration unit, image data required by the host are read from the image temporary storage device and processed by the back-end digital compensation and adjustment unit, and the image data after the back-end image processing are stored in the FIFO buffering unit for reading in order to be outputted to the host.

6. A digital image processing apparatus according to claim 5, wherein the buffer write unit is capable of adjusting color depth of data received by the buffer write unit.

7. A method for digital image processing for use in an image acquisition system, the image acquisition system further comprising an optical device, an analog front-end processing device, a digital image processing apparatus, and an image temporary storage device, the optical device for converting an image into analog data electronically, the analog front-end processing device, coupled to the optical device, for converting the analog data into digital image data, the digital image processing apparatus, coupled to the analog front-end processing device, for processing the digital image data and outputting the digital image data after processing to a host, the image temporary storage device, coupled to the digital image processing apparatus, being as a buffer for the digital image processing apparatus, the digital image processing apparatus comprising a front-end digital compensation and adjustment unit, a back-end digital compensation and adjustment unit, a front-end FIFO buffering unit, a FIFO buffering unit for writing, a FIFO buffering unit for reading, and an access arbitration unit, the method comprising:
(a) by using the access arbitration unit, writing a table required by the front-end FIFO buffering unit into the front-end FIFO buffering unit, and clearing the FIFO buffering unit for reading;
(b) by using the access arbitration unit, determining whether the front-end FIFO buffering unit, or the FIFO buffering unit for reading, or the FIFO buffering unit for writing has a request for updating data; if so, performing step (c);
(c) by using the access arbitration unit, selecting a unit from a list of units, each of which is determined to have a request for updating data in the step (b), and performing updating data for the unit selected; and
(d) repeating the step (b).

8. A method according to claim 7, wherein the access arbitration unit further has:
a direct state, for indicating the image temporary storage device being accessible directly, for use in testing or initialization;
a front-end state, for indicating the front-end FIFO buffering unit having access to the image temporary storage device;
a write state, for indicating the FIFO buffering unit for writing having access to the image temporary storage device; and
a read state, for indicating the FIFO buffering unit for reading having access to the image temporary storage device.

9. A method according to claim 8, wherein when the access arbitration unit is in the direct state, the access arbitration unit determines access to the image temporary storage device by:
determining whether there is a request for updating data of the front-end FIFO buffering unit; if so, the access arbitration unit going to the front-end state and operating according to the request for updating data of the front-end FIFO buffering unit;
determining whether there is a request for updating data of the FIFO buffering unit for writing; if so, the access arbitration unit going to the write state and operating according to the request for updating data of the FIFO buffering unit for writing;
determining whether there is a request for updating data of the FIFO buffering unit for reading; if so, the access arbitration unit going to the read state and operating according to the request for updating data of the FIFO buffering unit for reading; and
if the access arbitration unit detecting that there is no request for updating data, the access arbitration unit remaining in the direct state.

10. A method according to claim 8, wherein when the access arbitration unit is in the front-end state, the access arbitration unit determines access to the image temporary storage device by:
determining whether there is a request for updating data of the FIFO buffering unit for writing; if so, the access arbitration unit going to the write state and operating according to the request for updating data of the FIFO buffering unit for writing;
determining whether there is a request for updating data of the FIFO buffering unit for reading; if so, the access arbitration unit going to the read state and operating according to the request for updating data of the FIFO buffering unit for reading; and
if the access arbitration unit detecting that there is no request for updating data, the access arbitration unit entering the direct state.

11. A method according to claim 8, wherein when the access arbitration unit is in the write state, a determination of access to the image temporary storage device is made by:
determining whether there is a request for updating data of the FIFO buffering unit for writing; if so, the access arbitration unit going to the write state and operating according to the request for updating data of the FIFO buffering unit for writing;
determining whether there is a request for updating data of the FIFO buffering unit for reading; if so, the access arbitration unit going to the read state and operating according to the request for updating data of the FIFO buffering unit for reading; and
if the access arbitration unit detecting that there is no request for updating data, the access arbitration unit entering the direct state.

12. A method according to claim 8, wherein when the access arbitration unit is in the read state, the access arbitration unit determines access to the image temporary storage device by:
determining whether there is a request for updating data of the front-end FIFO buffering unit; if so, the access arbitration unit going to the front-end state and operating according to the request for updating data of the front-end FIFO buffering unit;
determining whether there is a request for updating data of the FIFO buffering unit for writing; if so, the access arbitration unit going to the write state and operating according to the request for updating data of the FIFO buffering unit for writing;
determining whether there is a request for updating data of the FIFO buffering unit for reading; if so, the access arbitration unit going to the read state and operating according to the request for updating data of the FIFO buffering unit for reading; and
if the access arbitration unit detecting that there is no request for updating data, the access arbitration unit entering the direct state.

13. A method according to claim 8, wherein, initially, the front-end FIFO buffering unit sends the access arbitration unit a front-end request for filling the front-end FIFO buffering unit with data and then the front-end FIFO buffering unit sends the front-end request when:
(a) the front-end FIFO buffering unit's amount of valid data is less than a front-end threshold, and
(b) the front-end FIFO buffering unit does not obtain the access to the image temporary storage device, and
(c) data processed by the front-end digital compensation and adjustment unit are not the last data.

14. A method according to claim 8, wherein the FIFO buffering unit for writing has no valid data initially and the FIFO buffering unit for writing sends a write request to the access arbitration unit when:
(a) an amount of valid data of the FIFO buffering unit for writing is greater than a write threshold or valid data processed by the FIFO buffering unit for writing are the last valid data, and
(b) the FIFO buffering unit for writing does not obtain the access to the image temporary storage device.

15. A method according to claim 8, wherein the FIFO buffering unit for reading has no valid data initially and the FIFO buffering unit for reading sends a write request to the access arbitration unit when:
(a) an amount of valid data of the FIFO buffering unit for reading is less than a read threshold, and
(b) an amount of valid data of the image temporary storage device is not zero.
